(19) United States
(12) Patent Application Publication
(10) Pub. No.: US 2023/0405687 A1
(43) Pub. Date: Dec. 21, 2023

(54) CUTTING TOOL

(71) Applicant: Sumitomo Electric Hardmetal Corp., Itami-shi, Hyogo (JP)

(72) Inventors: Yuta SUZUKI, Itami-shi, Hyogo (JP); Shinya IMAMURA, Itami-shi, Hyogo (JP)

(73) Assignee: Sumitomo Electric Hardmetal Corp., Itami-shi, Hyogo (JP)

(21) Appl. No.: 18/018,890

(22) PCT Filed: Jun. 15, 2022
(86) PCT No.: PCT/JP2022/023996

§ 371 Date: Jan. 31, 2023

(51) Int. Cl. B23B 27/14

(52) U.S. Cl. CPC B23B 27/148; B23B 2228/105

(57) ABSTRACT

A cutting tool comprising a base material and a coating, wherein the coating includes a first layer having a multilayer structure in which a first unit layer and a second unit layer; a thickness of the first unit layer is 2 nm or more and less than 50 nm; a thickness of the second unit layer is 2 nm or more and less than 50 nm; a thickness of the first layer is 1.0 μm or more and 20 μm or less, the first unit layer is TiₐAl_{b}B_{c}N, and the second unit layer is Ti_{d}AlₑB_{f}N, wherein 0.54≤a≤0.75, 0.24≤b≤0.45, 0<c≤0.10, a+b+c=1.00, 0.44≤d≤0.65, -.34≤e≤0.55, 0<f≤0.10, d+e+f=1.00, 0.05≤a−d≤0.20, and 0.05≤e−b≤0.20 are satisfied, and a percentage of the number of atoms of titanium to the total number of atoms of titanium, aluminum and boron is 50% or more in the first layer.

### TECHNICAL FIELD

The present disclosure relates to a cutting tool.

### BACKGROUND ART

Conventionally, coatings that coat a surface of a base material made of cemented carbide, sintered cubic boron nitride and the like have been developed in order to improve performance of cutting tools (for example, Patent Literature 1 and Patent Literature 2).

### CITATION LIST

### Patent Literature

PTL 1: Japanese Patent Laying-Open No. 2017-193004

PTL 2: Japanese Patent Laying-Open No. 2011-224717

### SUMMARY OF INVENTION

The cutting tool of the present disclosure is a cutting tool comprising a base material and a coating arranged on the base material, wherein
the coating includes a first layer;
the first layer has a multilayer structure in which a first unit layer and a second unit layer are alternately stacked;
a thickness of the first unit layer is 2 nm or more and less than 50 nm;
a thickness of the second unit layer is 2 nm or more and less than 50 nm;
a thickness of the first layer is 1.0 um or more and 20 μm or less,
the first unit layer is composed of TiₐAl_{b}B_{c}N, and
the second unit layer is composed of Ti₃AlₑB_{f}N,

wherein

0.54≤a≤0.75,

0.24≤b≤0.45,

0<c≤0.10,

a+b+c=1.00,

0.44≤d≤0.65,

0.34≤e≤0.55,

0<f≤0.10,

d+3+f=1.00,

0.05≤a−d≤0.20, and

0.05≤e−b≤0.20 are satisfied, and

a percentage of the number of atoms of titanium to the total number of atoms of titanium, aluminum arid boron is 50% or more in the first layer.

### BRIEF DESCRIPTION OF DRAWINGS

FIG. 1 is a schematic cross-sectional view illustrating an example of the configuration of the cutting tool according to one embodiment of the present disclosure.

FIG. 2 is a view explaining a measurement region when measuring the diameter of the largest inscribed circle of a crystal grain of a first layer.

FIG. 3 is a schematic view explaining a method for measuring the diameter of the largest inscribed circle of a crystal grain of a first layer, a schematic view illustrating a bright field image of a measurement field of view.

FIG. 3A is a view explaining positional relationship between a crystal grain, a first unit layer and a second unit layer.

FIG. 4 is a schematic cross-sectional view illustrating an example of the configuration of a film deposition apparatus.

FIG. 5 is a schematic cross-sectional view illustrating an example of the configuration of a film deposition apparatus.

### DETAILED DESCRIPTION

### Problem to be Solved by the Present Disclosure

In recent years, cost reduction of tools has been increasingly demanded, and the tools have been required for their longer lives. For example, in the machining of stainless steel, cutting tools with their long tool lives are required in terms of both high-speed, low-feed machining and low-speed, high-feed machining.

Then, an object of the present disclosure is to provide a cutting tool with a long tool life.

### ADVANTAGEOUS EFFECTS OF THE PRESENT DISCLOSURE

The cutting tool of the present disclosure can have a long tool life.

### Description of Embodiments

First, aspects of the present disclosure will be described by listing them.

(1) The cutting tool of the present disclosure is a cutting tool comprising a base material and a coating arranged on the base material, wherein

the coating includes a first layer;

the first layer has a multilayer structure in which a first unit layer and a second unit layer are alternately stacked;
a thickness of the first unit layer is 2 nm or more and less than 50 nm;
a thickness of the second unit layer is 2 nm or more and less than 50 nm;
a thickness of the first layer is 1.0 μm or more and 20 μm or less,
the first unit layer is composed of TiₐAl_{b}B_{c}N, and
the second unit layer is composed of Ti_{d}AlₑB_{f}N,

wherein

0.54≤a≤0.75

0.24≤b≤0.45,

0<c≤0.10,

a+b+c=1.00,

0.44≤d≤0.65,

0.34≤e≤0.55,

0<f≤0.10,

d+e+f=1.00,

0.05≤a−d≤0.20, and

0.05≤e−b≤0.20 are satisfied, and

a percentage of the number of atoms of titanium to the total number of atoms of titanium, aluminum and boron is 50% or more in the first layer.

The cutting tool of the present disclosure can have a long tool life.

(2) The first layer is composed of a plurality of crystal grains and

the diameter of the largest inscribed circle of the crystal grain is 50 nm or smaller.

Accordingly, the microstructure of the first layer is dense, thereby improving wear resistance and chipping resistance of the cutting tool.

(3) In an X-ray diffraction spectrum of the first layer, a half width of a diffraction peak derived from (200) plane of a cubic crystal is preferably 0.2° or more and 2.0° or less.

Accordingly, the proportion of the cubic crystal structure in the first layer is high, thereby enabling high hardness of the first layer, which results in improvements in the wear resistance of the cutting tool.

(4) Nanoindentation hardness H of the first layer at 25° C. is preferably 30 GPa

or greater. Accordingly, the wear resistance of the cutting tool is improved.

(5) A ratio of a nanoindentation hardness H (GPa) of the first layer at 25° C. to a Young's modulus E (GPa) of the first layer at 25° C., HIE, is preferably 0.07 or more.

Accordingly, the cutting tool can have excellent wear resistance as well as chipping resistance, enabling further improvements in its tool life.

### Details of Embodiments of the Present Disclosure

Specific examples of the cutting tool of the present disclosure will be described with reference to the drawings below. In the drawings of the present disclosure, the same reference sign represents the same portion or equivalent portion. Moreover, dimensional relationships such as length, width, thickness, and depth have been changed as necessary for the sake of clarity and simplification of the drawings, and do not necessarily represent actual dimensional relationships.

In the present disclosure, the notation in the form “A to B” refers to the upper limit and lower limit of the range (i.e., A or more and B or less). In a case in which no units are described in A, but only in B, the units in A are the same as that in B.

Compounds and the like when represented by chemical formulae in the present disclosure shall include all conventionally known atomic ratios as long as the atomic ratios thereof and not particularly limited, and should not necessarily be limited only to those in their stoichiometric ranges. For example, when described as “TiN”, the ratio of the number of atoms constituting TiN includes all conventionally known atomic ratios.

In the present disclosure, when each of one or more numerical values is described as lower limits and upper limits of a numerical range, combinations of any one numerical value described for the lower limit and any one numerical value described for the upper limit shall also be disclosed. For example, when a1 or more, b1 or more, or c1 or more is described as the lower limit, and a2 or less, b2 or less, and c2 or less as the upper limit, a1 or more and a2 or less, a1 or more and b2 or less, a1 or more and c2 or less, and b1 or more and a2 or less, b1 or more and to b2 or less, b1 or more and c2 or less, c1 or more and a2 or less, and c1 or more and b2 or less, and c1 or more and c2 or less, shall be disclosed.

### Embodiment 1: Cutting Tool

One embodiment of the cutting tool of the present disclosure (hereinafter also referred to as “present embodiment”) is a cutting tool comprising a base material and a coating arranged on the base material, wherein
the coating includes a first layer;
the first layer has a multilayer structure in which a first unit layer and a second unit layer are alternately stacked;
a thickness of the first unit layer is 2 nm or more and less than 50 nm;
a thickness of the second unit layer is 2 nm or more and less than 50 nm;
a thickness of the first layer is 1.0 μm or more and 20 μm or less,
the first unit layer is composed of TiₐAl_{b}B_{c}N, and
the second unit layer is composed of Ti_{d}AlₑB_{f}N,

wherein

0.54≤a≤0.75,

0.24≤b≤0.45,

0<c≤0.10,

a+b+c=1.00

0.44≤d≤0.65,

0.34≤e≤0.55,

0<f≤0.10,

d+e+f=1.00,

0.055≤a−d≤0.20, and

0.05e−b≤0.20 are satisfied, and

a percentage of the number of atoms of titanium to the total number of atoms of titanium, aluminum and boron is 50% or more in the first layer.

The cutting tool of the present disclosure can have a long tool life. The reason therefore is conjectured as follows.
(i) The coating of the cutting tool of the present disclosure includes a first layer having a multilayer structure in which the first unit layer and the second unit layer are alternately stacked. The composition of the first unit layer and that of the second unit layer are different from each other, This enables to inhibit propagation of cracks occurring from a surface of the coating in the vicinity of an interface between the first unit layer and the second unit layer upon using the cutting tool. Moreover, the thickness of each of the first unit layer and the second unit layer, which is very small and 2 nm or more and less than 50 nm, allows the first layer and second layer in a large number to be stacked, thereby further enhancing inhibition effect of crack propagation. Therefore, large scale damage to the coating can be inhibited, thereby prolonging a tool life of the cutting tool.
(ii) In the first layer described above, the composition of the first unit layer and that of the second unit layer are different enough to inhibit crack propagation as described in (i) above as well as are similar to the extent that allows the crystal lattice to be continuous, as a result of which the first unit layer and the second unit layer are inhibited for delaminating therebetween, thereby prolonging a tool life of the cutting tool,
(iii) In the above first layer, a percentage of the number of atoms of titanium (Ti) to the total number of atoms of titanium, aluminum and boron (Ti+Al+B). which is {Ti/(Ti−Al+B)}×100, is 50% or more. According thereto, the first layer can have excellent the wear resistance and chipping resistance. Furthermore, in the above first layer, a percentage of the number of atoms of boron (B) to the total number of atoms of titanium, aluminum and boron (Ti+Al+B), which is {B/(Ti+Al+B)}×100, is 10% or less. According thereto, the crystal grains constituting the first layer micronize, further improving the wear resistance and chipping resistance. Therefore, the tool life of the cutting tool is prolonged.

### <Cutting Tool>

A shape, application and the like of the cutting tool of the present embodiment are not particularly limited as long as it is a cutting tool, The cutting tool of the present embodiment can be, for example, drills, end mills, replacement blade inserts for milling, replacement blade inserts for turning, metal saws, gear cutting tools, reamers, taps, inserts for pin milling of crankshafts, or the like.

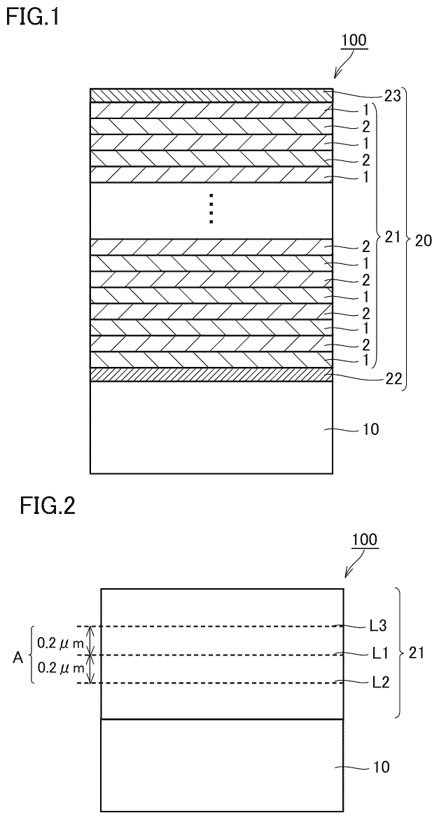

FIG. 1 is a schematic partial cross-sectional view illustrating an example of the configuration of the cutting tool of the present embodiment. A cutting tool 100 comprises a base material 10 and a coating 20 arranged on base material 10.

### <<Base Material>>

Base material 10 is not particularly limited, Base material 10 can be configured of, for example, such as cemented carbide, cermet, high-speed steel, ceramics, a cubic boron nitride sintered material, and a diamond sintered material. Base material 10 is preferably made of cemented carbide, This is because the cemented carbide has excellent wear resistance.

Cemented carbide is a sintered material composed mainly of WC (tungsten carbide) particles. The cemented carbide includes a hard phase and a binder phase. The hard phase contains WC particles. The binder phase bonds the WC particles to each other. The binder phase contains, for example, Co (cobalt) and the like. The binder phase may further contain, for example, TiC (titanium carbide), TaC (tantalum carbide), NC (niobium carbide), or the like.

The cemented carbide may contain impurities that are unavoidably mixed in during a manufacturing process. The cemented carbide may also contain free carbon or an anomalous layer referred to as “η-layer” in the microstructure. Furthermore, the cemented carbide may undergo surface modification treatment. For example, the cemented carbide may contain a β-free layer or the like on a surface thereof.

The cemented carbide preferably contains 87% by mass or more and 96% by mass or less of WC particles and contains 4% by mass or more and 13% by mass or less of Co. The WC particle preferably has an average particle size of 0.2 μm or larger and 4 μm or smaller.

Co is softer than the WC particle. As will be described below, soft Co can be removed by ion bombardment treatment on a surface of base material 10. With cemented carbide having the aforementioned composition and the WC particle having the aforementioned average particle size, moderate convex and concave will be formed on a surface after Co was removed. Coating 20 formed on such a surface is considered to exhibit an anchor effect, thereby improving adhesiveness between coating 20 and base material 10.

Here, the particle size of the WC particle indicates the diameter of a circle circumscribed by a two-dimensional projected image of the WC particle. The particle size is determined with a scanning electron microscope (SEM) or a transmission electron microscope (TEM). Namely, cemented carbide is cut, and the cut surface is observed by SEM or TEM. The diameter of the circle circumscribed to the WC particle in an observed image is regarded as the particle diameter of the WC particle. In the observed image, the diameters of 10 or more (preferably 50 or more and more preferably 100 or more) of WC particles selected at random in the observed image are measured, and the arithmetic mean value thereof is considered to be an average particle diameter of the WC particles. Upon the observation, the cut surface is desirably subjected to cross-section processing by a cross-section polisher (CP) or focused ion beam (FIB) or the like.

### <<Coating>>

Coating 20 is arranged on base material 10. Coating 20 may be arranged on a portion of a surface of base material 10 or on the entire surface thereof. However, coating 20 shall be arranged on at least a portion of the surface of base material 10, which corresponds to a cutting edge.

Coating 20 includes a first layer 21. Coating 20 may include other layers as long as it includes first layer 21. For example, coating 20 may include a second layer 22 arranged between base material 10 and first layer 21 and/or a third layer 23 arranged on the top surface of coating 20. A publicly known underlying layer can be applied to the second layer. Examples of the underlying layer include a TiCN layer, a TiN layer, a TiCNO layer, or the like. A publicly known surface layer can be applied to the third layer. The surface layers include a TiC layer, TiN layer, TiCN layer, or the like.

The stacked configuration of coatings 20 is not necessarily uniform throughout the entire coating 20, and may partially be different.

The thickness of coating 20 is preferably 1.0 μm or more and 25 μm or less. Coating 20 having a thickness of 1.0 pm or more improves the wear resistance. Coating 20 having a thickness of 25 μm or less improves the chipping resistance. The thickness of coating 20 is preferably 1.0 μm or more and 25 μm or less, more preferably 2.0 μm or more and 16 μm or less, and still more preferably 3.0 μm or more and 12 μm or less. Here, the thickness of the coating refers to the total summation of each thickness of the layers constituting the coating. Examples of the “layer constituting the coating” include, for example, first layer, second layer, third layer, and the like.

The thickness of each layer constituting the coating is determined by obtaining a thin sample thereinafter also referred to as “cross-sectional sample”) of a cross-section parallel to the normal direction of the surface of the base material of the cutting tool and observing the cross-sectional sample with a scanning transmission electron microscope (STEM). Examples of the scanning transmission electron microscope include, for example, a JEM-2100F (trade name) manufactured by JEOL Ltd. Observation magnification of the cross-sectional sample is set at 5,000 to 10,000 times, thicknesses of each layer are measured at five locations thereof, and an arithmetic mean of the thicknesses is used as the “thickness of each layer.”

It has been confirmed that as long as the same cutting tool is used for measurement, there is no variation in measurement results even though a measurement location is arbitrarily selected.

In the present embodiment, a crystal grain constituting coating 20 is preferably a cubic crystal. The cubic crystal increases hardness and prolongs a tool life.

### <<First Layer>>

A first layer 21 has a multilayer structure in which first unit layer 1 and second unit layer 2 are alternately stacked, As long as first layer 21 includes one or more of first unit layers 1 and one or more of second unit layers 2, respectively, the number of stacking is not limited. The number of stacking indicates the total number of first unit layer 1 and second unit layer 2, included in first layer 21. The number of stacking is preferably more than 10 and 5,000 or less, preferably 200 or more and 5,000 or less, more preferably 400 or more and 2,000 or less, and still more preferably 500 or more and 1,000 or less. In first layer 21, the layer closest to base material 10 may be first unit layer 1 or second unit layer 2. Moreover, in first layer 21, the layer farthest from base material 10 may be first unit layer 1 or second unit layer 2.

The thickness of the first layer is 1.0 μm or more and 20 μm or less. The first layer having a thickness of 1.0 μm or more improves the wear resistance. The first layer having a thickness of 20 μm or less improves the chipping resistance. The lower limit of the thickness of the first layer is preferably 1.0 μm or more, more preferably 2.0 μm or more, and still more preferably 3.0 μm or more. The upper limit of the thickness of the first layer is preferably 20 μm or less, preferably 18 μm or less, more preferably 16 μm or less, and still more preferably 12 μm or less. The thickness of the first layer is 1.0 μm or more and 20 μm or less, preferably 2.0 μm or more and 16 μm or less, and more preferably 3.0 μm or more and 12 μm or less.

### <<Thicknesses of First Unit Layer and Second Unit Layer>>

First unit layer 1 and second unit layer 2 each have a thickness of 2 nm or more and less than 50 nm. The alternate repetition of such thin layers can inhibit cracks from progressing. First unit layer 1 and second unit layer 2 each having a thickness of less than 2 nm may lower the inhibition effect of crack propagation due to mixing of compositions of first unit layer 1 and second unit layer 2. Further, first unit layer 1 and second unit layer 2 each having a thickness of 50 nm or more may lower the inhibition of interlayer delamination,

The lower limit of the thickness of the first unit layer is 2 nm or more, preferably 4 nm or more, more preferably 6 nm or more, and still more preferably 8 nm or more. The upper limit of the thickness of the first unit layer is less than 50 nm, preferably 46 nm or less, preferably 40 nm or less, and more preferably 30 nm or less. The thickness of the first unit layer is 2 nm or more and less than 50 nm, preferably 4 nm or more to 40 nm or less and more preferably 6 nm or more and 30 nm or less.

The lower limit of the thickness of the second unit layer is 2 nm or more, preferably 4 nm or more, more preferably 6 nm or more, and still more preferably 8 nm or more. The upper limit of the thickness of the second unit layer is less than 50 nm, preferably 47 nm or less, more preferably 40 nm or less, and still more preferably 30 nm or less. The thickness of the second unit layer is 2 nm or more and less than 50 nm, preferably 4 nm or more and 40 nm or less, and more preferably 6 nm or more and nm or less.

The respective thicknesses of the first unit layer and the second unit layer are measured as follows. A thin sample (hereinafter also referred to as “cross-sectional sample”) of a cross-sectional section of the cutting tool parallel to the normal direction of a surface of the base material is obtained. Then the cross-sectional sample is observed with a scanning transmission electron microscope (STEM). Examples of the scanning transmission electron microscope include, for example, a JEM-2100F (trade name) manufactured by JEOL Ltd. Observation magnification of the cross-sectional sample shall be adjusted according to the thicknesses of first unit layer 1 and second unit layer 2. For example, the observation magnification can be approximately 1 million times. In one first unit layer, thicknesses are measured at five locations thereof. An arithmetic mean value of the thicknesses of the five locations in the first unit layer is calculated to determine the thickness of the first unit layer that is the arithmetic mean value. In one second unit layer, thicknesses are measured at five locations thereof.

For each of the five different first unit layers, the thickness of the first unit layer is measured according to the procedure described above. An arithmetic mean value of the thicknesses of the five first unit layers is determined. The arithmetic mean value is taken as the thickness of the first unit layer. For each of the five different second unit layers, the thickness of the second unit layer is measured according to the procedure described above. An arithmetic mean value of the thicknesses of the five second unit layers is determined. The arithmetic mean value is taken as the thickness of the second unit layer.

It has been confirmed that there is no variation in the measurement results even. though the measurement location is arbitrarily selected, as long as measuring with the same cutting tool.

### <<Compositions of First Unit Layer and Second Unit Layer>>

The first unit layer is composed of TiₐAl_{b}B_{c}N, and the second unit layer is composed of Ti_{d}AlₑB_{f}N, wherein 0.54≤a≤0.75, 0.24≤b≤0.45, 0<c≤0.10, a+b+c=1.00, 0.44≤d≤0.65, 0.34≤e≤0.55, 0<f≤0.10, d+e+f=1.00, 0.05≤a−d≤0.20, and 0.0525≤e−b≤0.20, are satisfied.

The compositions of the first unit layer and the second unit layer that satisfy 0.05≤a−d and 0.05≤e−b, allow the compositions of the first unit layer and the second unit layer to be diverged to the extent that cracks between first unit layer 1 and second unit layer 2 can be inhibited from propagating. At the same time, satisfying a−d≤0.20 and e−b≤0.20 allows the compositions of the first unit layer and the second unit layer to be approximated to the extent that interlayer delamination between first unit layer 1 and second unit layer 2 can be inhibited. The compositions of first unit layer 1 and second unit layer 2 preferably satisfy the relationship 0.05≤a−d≤0.15 and 0.05≤e−b≤0.15 and more preferably 0.05≤a−d≤0.10 and 0.05≤e−b≤0.10. This further improves the inhibition effects of crack propagation and interlayer delamination.

In the first unit layer, the lower limit of “a” is 0.54 or more, preferably 0.57 or more and more preferably 0.60 or more, The upper limit of “a” is 0.75 or less, preferably 0.72 or less, and, more preferably 0.69 or less. “a” preferably satisfies 0.57≤a≤0.72 and more preferably 0.60≤a≤0.69.

In the first unit layer, the lower limit of “b” is 0.24 or more, preferably 0.27 or more, and more preferably 0.30 or more. The upper limit of “b” is 0.45 or less, preferably 0.42 or less, and more preferably 0.39 or less. “b” preferably satisfies 0.27≤b≤0.42 and more preferably 0.30≤b≤0.39.

In the second unit layer, the lower limit of “d” is 0.44 or more, preferably 0.47 or more, and more preferably 0.50 or more. The upper limit of “d” is 0.65 or less, preferably 0.62 or less, and more preferably 0.59 or less. “d” preferably satisfies 0.47≤d≤0.62 and more preferably 0.50≤d≤0.59.

In the second unit layer, the lower limit of “e” is 0.34 or more, preferably 0.37 or more, and more preferably 0.40 or more. The upper limit of “e” is 0.55 or less, preferably 0.52 or less, and more preferably 0.49 or less. “e” preferably satisfies 0.37≤e≤0.52 and more preferably 0.40≤e≤0.49.

Where 0<c5_0.10 is satisfied in the first unit layer and O<E:0.10 is satisfied in the second unit layer, the crystal grains constituting the first layer micronize, thereby further improving wear resistance and chipping resistance.

In the first unit layer, the lower limit of “c” is more than 0, preferably 0.01 or more and more preferably 0.02 or more, The upper limit of “c” is 0.10 or less, preferably 0.09 or less, and more preferably 0.08 or less. “c” preferably satisfies 0.01≤c≤0.09 and more preferably 0.02≤c≤0.08.

In the second unit layer, the lower limit of “f” is more than 0, preferably 0.01 or more and more preferably 0.02 or more. The upper limit of “f” is 0.10 or less, preferably 0.09 or less, and more preferably 0.08 or less. “f” preferably satisfies 0.01≤f≤0.09 and more preferably 0.02≤f≤0.08.

The subscripts of a b, c in TiₐAl_{b}B_{c}N of the first unit layer, and d, e, f in Ti_{d}Al_{c}B_{f}N of the second unit layer were identified by measuring the composition of each layer by energy dispersive X-ray spectrometry (EDX). A TEM-EDX is used for composition analysis. Examples of the EDX apparatus include a JED-2300 (trade name) manufactured by JEOL Ltd.

The above composition analysis is conducted by the following procedure. A thin sample (hereinafter referred to as “cross-sectional sample”) of a cross-section parallel to the normal direction of a surface of the base material of the cutting tool is obtained. While observing the cross-sectional sample with TEM, EDX analysis is conducted at five points arbitrarily selected within one first unit layer 1 or one second unit layer 2. The first unit layer and the second unit layer are distinguishable due to difference in contrast. Here, the “five points arbitrarily selected” shall be selected from grains that differ from each other. The composition of each of the first unit layer and the second unit layer is identified by arithmetically averaging composition ratios of each element, obtained from. the five measurements.

Compositions of five layers of each of the first unit layer and the second unit layer are analyzed and the second unit layer, and an average composition of the first unit layer for the five layers and an average composition of the second unit layer for the five layers are determined, respectively. The average composition of the first unit layer for the five layers is taken as a composition of the first unit layer; and the average composition of the second unit layer for the five layers is taken as a composition of the second unit layer. Based on these compositions, a, b, c, d, e, and fare identified.

As long as the measurement is carried out on the same cutting tool, it has been confirmed that there is no variation in the measurement results even though measurement points are arbitrarily selected.

### <<Composition of First Layer>>

In the first layer, the percentage of the number of atoms of titanium to the total number of atoms of titanium, aluminum and boron (hereinafter also referred to as “titanium content in the first layer”) is 50% or more. Accordingly, the first layer can have excellent wear resistance and chipping resistance. The lower limit of the titanium content in the first layer is 50% or more from the viewpoint of improving the wear resistance and chipping resistance, preferably 53% or more, and more preferably 56% or more. The upper limit of the titanium content in the first layer is preferably 72% or less and more preferably 69% or less from the viewpoint of improving heat resistance. The titanium content in the first layer is preferably 50% or more and 72% or less, more preferably 53% or more and 72% or less, and still more preferably 56% or more and 69% or less.

The titanium content in the first layer is measured by TEM-EDX. Examples of an EDX apparatus includes an apparatus such as a JED-2300 (trade name) manufactured by JEOL Ltd. The titanium content in the first layer is measured by the following procedure.

A thin sample (hereinafter also referred to as “cross-sectional sample”) of a cross-section parallel to the normal direction of a surface of the base material of the cutting tool is obtained. While observing the cross-sectional sample by TEM, EDX analysis is carried out at five fields of view arbitrarily selected within the first layer. Here, “five fields of view arbitrarily selected” are set so as not to overlap with each other. The range of one field of view is 200×200 nm. The arithmetic mean of the titanium content values obtained from the measurements of the five fields of view is taken as the titanium content of the first layer.

As long as the measurement is carried out on the same cutting tool, it has been confirmed that there is no variation in the measurement results even though measurement points are arbitrarily selected.

### <<Diameter of Largest Inscribed Circle of Crystal Grains of First Layer>>

The first layer is preferably composed of a plurality of crystal grains with the diameter of the largest inscribed circle of the crystal grain of 50 nm or smaller. According thereto, the first layer has a dense microstructure, thereby improving the wear resistance and chipping resistance of the cutting tool. The first layer of the present disclosure may include a region that does not constitute a crystal grain (region where atoms are arranged at random) together with the plurality of crystal grains to the extent that the effect of the present disclosure is not impaired.

The upper limit of the diameter of the largest inscribed circle of the above crystal grain is preferably 50 nm or smaller from the viewpoint of improving the wear resistance and chipping resistance, more preferably 45 nm or smaller, and still more preferably 40 nm or smaller. The lower limit of the diameter of the largest inscribed circle of the crystal grain is preferably 5 nm or greater, more preferably 7 nm or greater, and still more preferably 10 nm or greater from the viewpoint of inhibiting a decrease in film hardness due to excessive micronization of crystal grains. The diameter of the largest inscribed circle of the crystal grain is preferably 5 nm or greater and 50 nm or smaller, more preferably 7 nm or greater and 45 nm or smaller, and still more preferably 10 nm or greater and 40 nm or smaller.

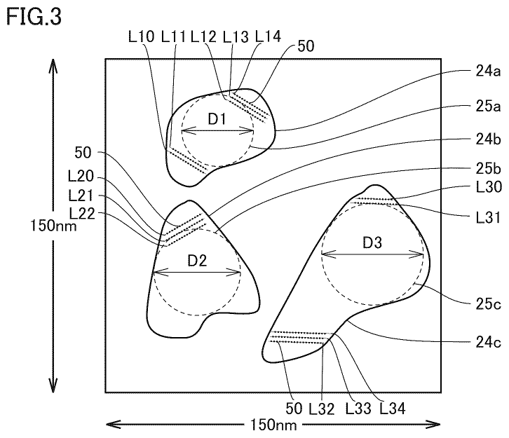

A method for measuring the diameter of the largest inscribed circle of the above crystal grain is as follows. A thin sample of a cross-section of the cutting tool parallel to the normal direction of a surface of the base material (thickness: approximately 10 to 100 nm, hereinafter also referred to as “cross-sectional sample”) is obtained. The cross-sectional sample is then subjected to transmission electron microscopy (TEM) to obtain a bright field image. The observation magnification is set to 1 million to 5 million times. As shown in FIG. 2, the bright field image is acquired so as to include a region A sandwiched between a line L2 at a distance of 0.2 μm from a line L1 indicating the center of the first layer in the thickness direction, to the base material side, and a line L3 at the distance of 0.2 μm from line L1 to the side on a surface of the coating. A rectangular measurement field of view of 150 nm×150 nm is arbitrarily set within region A.

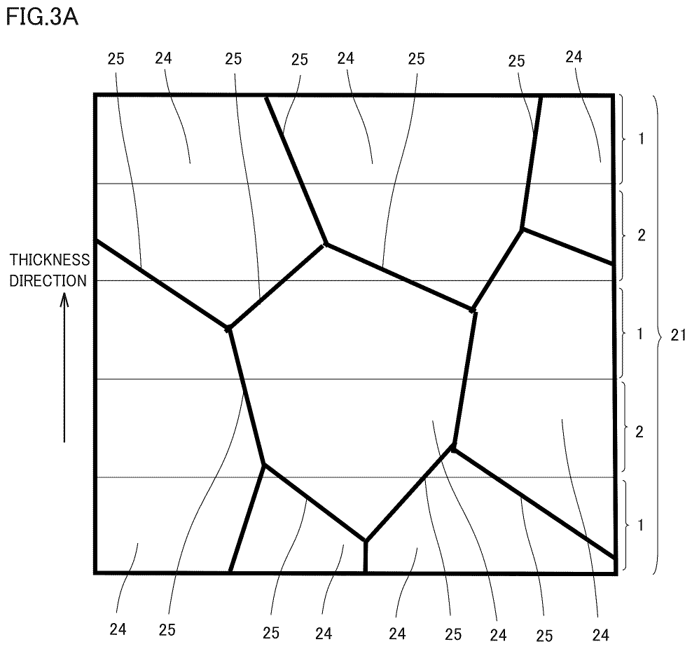

In the above measurement field of view, a region with atomic arrangement within ±0.5° or less is identified, and the region is defined as a crystal grain. In FIG. 3, a method for identifying the area with atomic arrangement within ±0.5° or less and the crystal grain will be described.

FIG. 3 is a schematic view illustrating an example of a bright field image of the above measurement field. In FIG. 3, atoms are indicated by black dots with a symbol 50. Note, however, in FIG. 3, a portion of the atoms is shown. In the bright field image, atoms 50 regularly arranged are connected by a line segment such that the distance between atoms is closest. In FIG. 3, the line segments are shown as L10 to L14, L20 to L22, and L30 to L34. A grain is defined as a region where the angle between each line segment is ±0.5° or less (i.e., −0.5° or more and 0.5° or less).

In FIG. 3, the angles between each line segment L10 to L14 stay within ±0.5° or less, and the region including these line segments corresponds to a grain 24a. The angles between each line segment L20 to L22 stay within ±0.5° or less, and the region including these line segments corresponds to a grain 24b. The angles between each line segment L30 to L34 stay within ±0.5° or less and the region including these line segments corresponds to a grain 24c.

The diameter of the largest inscribed circle of each grain in the above measurement field of view will be determined. The diameter of the largest inscribed. circle refers to the diameter of the largest inscribed circle that can be drawn inside the grain and contacts at least a portion of the outer edge of the grain.

In FIG. 3, the diameter of the largest inscribed circle 25a of grain 24a is D1. The diameter of the largest inscribed circle 25b of grain 24b is D2. The diameter of the largest inscribed circle 25c of grain 24c is D3. Where D1, D2 and D3 are all 50 nm or smaller, it is confirmed that the first layer shown in FIG. 3 is composed of a plurality of crystal grains, and the diameter of the largest inscribed circle of the crystal grain is 50 nm or smaller.

It has been confirmed that there is no variation in the measurement results of the diameter of the largest inscribed circle of the crystal grain even though the above measurement field of view is arbitrarily set as long as the same cutting tool is used for the measurement.

In FIG. 3, space is present between grain 24a, grain 24b, and grain 24c, however, crystal grains are actually present in the space. Since the thickness of a cross-sectional sample for TEM is approximately 10 to 100 nm, the bright field image also reflects information in the depth direction. In the region where plural crystal grains are overlapped in the thickness direction of the sample, regular atomic arrangement cannot be confirmed in the bright field image, Therefore, the area where plural crystal grains are overlapped is not discriminated as a crystal grain in the aforementioned identification method.

### <<Positional Relationship Between Crystal Grain and First Unit Layer as Well as Second Unit Layer>>

The positional relationships between a crystal grain and the first unit layer as well as the second unit layer will be described by using FIG. 3A. FIG. 3A is a view schematically illustrating a cross-section of the first layer of the present embodiment along the film thickness direction thereof. As shown in FIG. 3A, first layer 21 has a multilayer structure in which first unit layer 1 and second unit layer 2 are alternately stacked. In FIG. 3A, a plurality of crystal grains 24 is indicated, and the boundary between crystal grains 24 is indicated as a grain boundary 25. Each crystal grain 24 can consist of the first unit layer or the second unit layer. Moreover, each crystal grain 24 can be present across one or more first unit layers and one or more second unit layers. Namely, each crystal grain 24 can have a lamellar structure with the first unit layers and the second unit layers alternately stacked.

### <<X-ray Diffraction Spectrum>>

In an X-ray diffraction spectrum of the first layer, the half width of a diffraction peak derived from the (200) plane of a cubic crystal is preferably 0.2° or more and 2.0° or less. Here, the half width refers to a full width at half maximum (FWHM). According thereto, the first layer has a cubic crystal structure with fine crystal grains, enabling greater hardness of the first layer and thereby improving the wear resistance of the cutting tool. The half width of the diffraction peak derived from the (200) plane of the cubic crystal refers to the half width of a peak observed in the range of diffraction angle 2θ from 42° to 45° in an X-ray diffraction spectrum.

The lower limit of the aforementioned half width is preferably 0.2° or more. The upper limit of the above half width is preferably 2.0° or less from the viewpoint of improving the hardness of the first layer, more preferably 1.5° or less, and still more preferably 1.0° or less. The above half width is preferably 0.2′ or more and 2.0° or less, more preferably 0.2° or more and 1.5° or less, and still more preferably 0.2′ or more and 1.0° or less.

An X-ray diffraction spectrum of the first layer was measured by using a “SmartLab” (trademark) manufactured by Rigaku Corporation under the following conditions.

X-ray source: Cu-kα ray

X-ray output: 45 kV, 40 mA

Detector: One dimensional semiconductor detector

Measurement range of diffraction angle 2θ: 20° to 90°

Scanning speed: 10°/min

### <<Nanoindentation Hardness of First Layer>>

Nanoindentation hardness H of the first layer at 25° C. is preferably 30 GPa or greater. Accordingly, the wear resistance of the cutting tool is improved. The lower limit of nanoindentation hardness H is preferably 30 GPa or greater, more preferably 34 GPa or greater, and still more preferably 38 GPa or greater. The upper limit of nanoindentation hardness H is not particularly limited, and can be set to 60 GPa or smaller from the viewpoint on manufacturing. Nanoindentation hardness H is preferably 30 GPa or greater and 60 GPa or smaller, and more preferably 34 GPa or greater and 60 GPa or smaller, and still more preferably 38 GPa or greater and 60 GPa or smaller.

Nanoindentation hardness H of the above first layer at 25° C. is calculated by a nanoindentation method complied with the standard procedure set forth in “ISO 14577-1:2015 Metallic materials-Instrumented indentation test for hardness and materials parameters.” A measurement apparatus that is an “ENT-1100a” manufactured by Elionix Inc,, is used. An indentation load of an indenter is 1 g, Indentation of the indenter is conducted along a cross-section of the first layer in the vertical direction (i.e., parallel to a surface of the base material) for the first layer exposed in the cross-section parallel to the normal direction of the surface of the base material.

The aforementioned measurement is conducted for five measurement samples, and an average value of the nanoindentation hardness obtained for each sample is taken as nanoindentation hardness of the first layer. Data that appear to be anomalous values at first glance shall be excluded.

It has been confirmed that there is no variation in the measurement results even though measurement points are arbitrarily selected, as long as the same cutting tool is used for measurement.

### <<H/E in First Layer>>

A ratio of nanoindentation hardness H (GPa) of the first layer at 25° C. to Young's modulus E (GPa) of the first layer at 25° C., H/E, is preferably 0.070 or more. According thereto, the cutting tool can have excellent wear resistance as well as chipping resistance, thereby further improving the tool life. From the viewpoint of excellent balance between the wear resistance and chipping resistance, the H/E value is preferably 0.070 or more, more preferably 0.073 or more, and still more preferably 0.076 or more. The upper limit of H/E is not particularly limited, and can be set to 0.120 or less from the viewpoint on manufacturing. H/E is preferably 0.070 or more and 0.120 or less, more preferably 0.073 or more and 0.120 or less, and still more preferably 0.076 or more and 0.120 or less.

The aforementioned nanoindentation hardness H is preferably 30 GPa or greater and 50 GPa or smaller, more preferably 35 GPa or greater and 50 GPa or smaller, and still more preferably 40 GPa or greater and 50 GPa or smaller.

Young's modulus E is preferably 350 GPa or greater and 600 GPa or smaller, more preferably 350 GPa or greater and 550 GPa or smaller, and still more preferably 350 GPa or greater and 500 GPa or smaller. Young's modulus E is measured by the same method and under the same conditions as nanoindentation hardness H described above.

### Embodiment 2: Method for Manufacturing Cutting Tool

In Embodiment 2, a method for manufacturing the cutting tool of Embodiment 1 will be described. The manufacturing method can include a step of preparing a base material and a step of forming a coating on the base material. Details of each step will be described below.

### <<Step of Preparing Base Material>>

In the step of preparing a base material, a base material 10 is prepared. Base material 10 that is the base material described in Embodiment 1 can be used.

### <<Step of Forming a Coating>>

In the step of forming a coating, a film 20 is formed on base material 10. In the present embodiment, a physical vapor deposition (PVD) method can be employed to form film 20. Examples of the PVD method include an Arc Ion Plating (AIP) method, a balanced magnetron sputtering (BMS) method, and an unbalanced magnetron sputtering (UBMS) method, and the like. In the present embodiment, the arc ion plating method is preferred.

In the AIP method, an arc discharge is generated with a target material as a cathode. This evaporates and ionizes the target material. Ions are then deposited on a surface of base material 10 to which a negative bias voltage is applied. The AIP method is superior in ionization rate of the target material.

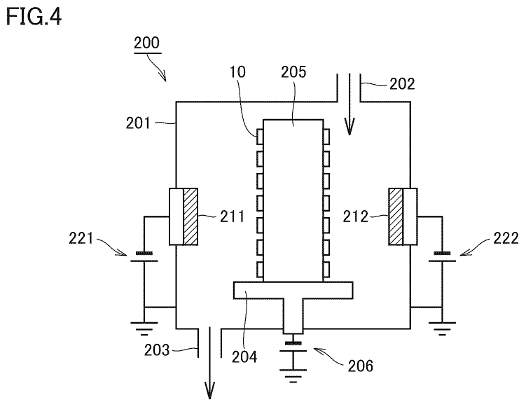

A deposition apparatus used in the AIP method will be described using FIGS. 3 and 4. As shown in FIG. 3, a deposition apparatus 200 is equipped with a chamber 201. Chamber 201 has a gas inlet port 202 for introducing a raw material gas to chamber 201 and a gas exhaust port 203 for discharging the material gas from inside chamber 201 to an outside. Gas exhaust port 203 is connected to a vacuum pump, which is not shown in the figure. Pressure in chamber 201 is adjusted by the amount of gas introduced and discharged.

A rotary table 204 is disposed in chamber 201. A base material holder 205 for holding base material 10 is attached to rotary table 204, Base material holder 205 is connected to a negative electrode of a bias power supply 206. A positive electrode of bias power supply 206 is grounded.

As shown in FIG. 4, a plurality of target materials 211, 212, 213, 214 is attached to side walls of chamber 201, As shown in Fig, 3, each of target materials 211 and 212 is connected to negative electrodes of direct current power supplies 221 and 222. Direct current power supplies 221 and 222 are variable power supplies, and their positive electrodes are grounded. The same is true for target materials 213 and 214, although not shown in FIG. 3. Specific operations will be described below.

A base material holder 205 holds base material 10. Using a vacuum pump, chamber 201 is adjusted to the inside pressure of 1.0×10⁻⁴ Pa. While rotating rotary table 204, base material 10 is adjusted to a temperature of 500° C. by a heater (not shown) attached to deposition apparatus 200.

Ar gas is introduced from gas inlet port 202, and chamber 201 is adjusted to the inside pressure of 3.0 Pa. While maintaining the same pressure, power supply 206 gradually varies its voltage and is finally adjusted to −1000 V. A surface of base material 10 is then cleaned by ion bombardment treatment with Ar ions.

Next, a coating in the case of including second layer 22 forms second layer 22 on a surface of base material 10. For example, a TiCN layer, TiN layer, or TiCNO layer is formed on the surface of base material 10.

Next, first layer 21 is formed on the surface of base material 10 or on a surface of second layer 22. A sintered alloy containing Ti, Al and B is used as a target material. Each target material is set at a predetermined position, nitrogen gas is introduced from gas inlet port 202 to form first layer 21 while rotating rotary table 204. Forming conditions of first layer 21 are as follows.

(Forming Condition of First Layer)

Base material temperature: 400 to 650° C.

Bias voltage : −400 to −30 V

Arc current : 80 to 200 A

Reaction gas pressure: 5 to 10 Pa

The base material temperature, reaction gas pressure, bias voltage, and arc current are set to constant values within the ranges described above, or varied continuously within the above ranges.

The first unit layer and second unit layer can be appropriately formed in combinations of the methods (A) to (D) below.

(A) In the AIP method, a plurality of target materials (sintered alloys) having different compositions with each other is used. For example, a composition of the target material used for forming the first unit layer can be Ti60-A130-B10 and a composition of the target material used for forming the second unit layer can be Ti50-A140-B10.

(B) In the AIP method, bias voltage applied to base material 10 during deposition is varied within the bias voltage (−400 to −30 V) described in the forming conditions of the first layer described above.

(C) In the AIP method, a gas flow rate is varied. For example, the gas flow rate upon forming of the first unit layer can be set to 500 sccm to 2000 sccm, and the gas flow rate upon forming of the second unit layer can be set to 500 sccm to 2000 sccm.

(D) In the AIP method, base material 10 is rotated to control a rotation cycle. For example, the rotation cycle can be set to 1 rpm to 5 rpm.

Next, a coating in the case of including a third layer 23, for example, forms third layer 23 on a surface of first layer 21 For example, a TiC layer, TiN layer or TiCN layer is formed on the surface of first layer 21.

From the above, cutting tool 100 including base material 10 and coating 20 arranged on base material 10 can be manufactured.

### Appendix 1

A cutting tool comprising a base material and a coating arranged on the base material, wherein
the coating includes a first layer;
the first layer has a multilayer structure in which a first unit layer and a second unit layer are alternately stacked;
a thickness of the first unit layer is 2 nm or more and less than 50 nm;
a thickness of the second unit layer is 2 nm or more and less than 50 nm;
a thickness of the first layer is 1.0 μm or more and 20 μm or less,
the first unit layer is composed of TiₐAl_{b}N, and
the second unit layer is composed of Ti_{d}AlₑB_{f}N,
   wherein

0.54≤a≤0.75,

0.24≤b≤0.45,

0<c≤0.10,

a+b+c=1.00,

0.44≤d≤0.65,

0.34≤e≤0.55,

0<f≤0.10,

d+e+f=1.00,

0.05≤a−e≤0.20, and

0.05≤e−b≤0.20 are satisfied, and

a percentage of the number of atoms of titanium to the total number of atoms of titanium, aluminum and boron is 50% or more in the first layer,

### Appendix 2

The cutting tool according to appendix 1, wherein
the first layer is composed of a plurality of crystal grains, and
the diameter of the largest inscribed circle of the crystal grain is 50 nm or smaller.

### Appendix 3

The cutting tool according to appendix 1 or 2, wherein in an X-ray diffraction spectrum of the first layer, a half width of a diffraction peak derived from (200) plane of a cubic crystal is 0.2″ or more and 2.0° or less.

### Appendix 4

The cutting tool according to any one of appendixes 1 to 3, wherein a nanoindentation hardness H of the first layer at 25° C. is 30 GPa or greater.

### Appendix 5

The cutting tool according to any one of claims 1 to 4, wherein a ratio of a nanoindentation hardness H of the first layer at 25° C. to a Young's modulus E of the first layer at 25° C., H/E, is 0.070 or more.

### Appendix 6

In the cutting tool of the present disclosure, the thickness of the coating is preferably 1.0 μm or more and 25 μm or less.

In the cutting tool of the present disclosure, the thickness of the coating is preferably 2.0 pin or more and 16 pm or less.

In the cutting tool of the present disclosure, the thickness of the coating is preferably 2.0 pm or more and 16 pm or less.

### Appendix 7

In the cutting tool of the present disclosure, the total number of stacking of the first unit layer and the second unit layer included in the first is preferably more than 10 and 5000 or less.

The above number of stacking is preferably 200 or more and 5000 or less.

The above number of stacking is preferably 400 or more and 2000 or less.

The above number of stacking is preferably 500 or more and 1000 or less.

### Appendix 8

In the cutting tool of the present disclosure, the thickness of the first layer is preferably 2.0 μm or more and 16 μm or less.

In the cutting tool of the present disclosure, the thickness of the first layer is preferably 3.0 μm or more and 12 μm or less.

### EXAMPLES

The present embodiment will be described more specifically by way of Examples. However, the present embodiment is not restricted by these Examples.

### <Fabrication of Cutting Tool>

A cutting tool is fabricated as follows and a tool life was evaluated.

### <<Samples 1 to 29, Samples 1-1 to 1-10 >>

A cutting insert made of cemented carbide (model number: SEMT13T3AGSR manufactured by Sumitomo Electric Hardmetal Ltd.) was prepared as a base material. The cemented carbide contains WC particles (90% by mass) and Co (10% by mass) The average particle size of the WC particle is 2 μm.

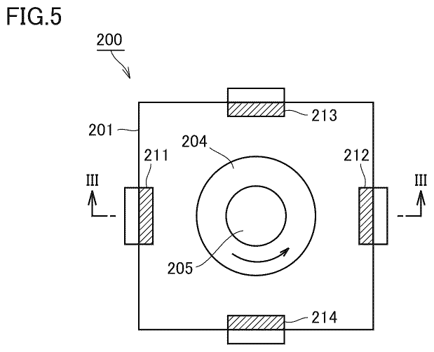

A coating was formed on the aforementioned base material by using a deposition apparatus having the configuration shown in FIGS. 4 and 5. First, a surface of the base material was cleaned by ion bombardment treatment with Ar ions. The specific conditions of the ion bombardment treatment are as described in Embodiment 2.

Next, sintered alloys having the compositions listed in the “First unit layer” and “Second unit layer” columns of “Target material composition” in Tables 1 and 2 were prepared as target materials, For example, in Sample 1, a sintered alloy with the ratio of the numbers of atoms of Ti, Al and B, “Ti:Al:B=0.54:0.44:0.02” as the target material for forming of the first unit layer and a sintered alloy with the ratio of the numbers of atoms of Ti, Al and B, “Ti:Al:B=0.40:0.56:0.04” as the target material for forming of the second unit layer, were prepared.

The target materials were set at predetermined positions in the deposition apparatus. Nitrogen gas was introduced from the gas inlet port, and the first layer was formed while rotating the rotary table. The first layer forming conditions (base material temperature, bias voltage, arc current, and reaction gas pressure) for each sample are as shown in the “First layer forming conditions” column of Tables 1 and 2. A rotation speed of the rotary table was adjusted according to the film thicknesses of the first unit layer and second unit layer.

TABLE 1

| | | | | | | | Upon first unit layer forming | | | | Upon second unit layer forming | | | |
|---|---|---|---|---|---|---|---|---|---|---|---|---|---|---|
| | | | | | | | Base | | | | Base | | | |
| | Target material composition | | | | | | material | | | Reaction | material | | | Reaction |
| | | | | Second unit | | | temp- | Bias | Arc | gas | temp- | Bias | Arc | gas |
| Sample | First unit layer | | | layer | | | erature | voltage | current | pressure | erature | voltage | current | pressure |
| No. | Ti | Al | B | Ti | Al | B | ° C. | V | A | Pa | ° C. | V | A | Pa |
| 1 | 0.54 | 0.44 | 0.02 | 0.40 | 0.56 | 0.04 | 500 | 100 | 160 | 5 | 500 | 100 | 80 | 5 |
| 2 | 0.65 | 0.25 | 0.10 | 0.60 | 0.37 | 0.03 | 550 | 100 | 120 | 8 | 550 | 100 | 120 | 8 |
| 3 | 0.60 | 0.35 | 0.05 | 0.45 | 0.40 | 0.15 | 450 | 100 | 120 | 6 | 450 | 100 | 120 | 6 |
| 4 | 0.60 | 0.35 | 0.05 | 0.60 | 0.37 | 0.03 | 500 | 150 | 150 | 10 | 500 | 150 | 150 | 10 |
| 5 | 0.61 | 0.32 | 0.07 | 0.60 | 0.37 | 0.03 | 400 | 100 | 120 | 8 | 400 | 100 | 150 | 8 |
| 6 | 0.65 | 0.25 | 0.10 | 0.50 | 0.45 | 0.05 | 500 | 100 | 150 | 6 | 500 | 100 | 100 | 6 |
| 7 | 0.61 | 0.32 | 0.07 | 0.45 | 0.40 | 0.15 | 550 | 100 | 150 | 7 | 550 | 100 | 15 | 7 |
| 8 | 0.60 | 0.35 | 0.05 | 0.50 | 0.40 | 0.10 | 500 | 150 | 150 | 8 | 500 | 150 | 120 | 8 |
| 9 | 0.54 | 0.44 | 0.02 | 0.50 | 0.45 | 0.05 | 650 | 300 | 80 | 6 | 650 | 300 | 80 | 6 |
| 10 | 0.60 | 0.35 | 0.05 | 0.50 | 0.45 | 0.05 | 500 | 100 | 120 | ? | 450 | 100 | 120 | 7 |
| 11 | 0.65 | 0.25 | 0.10 | 0.45 | 0.45 | 0.10 | 600 | 150 | 150 | 5 | 600 | 150 | 150 | 5 |
| 12 | 0.70 | 0.27 | 0.03 | 0.50 | 0.45 | 0.05 | 600 | 100 | 150 | 8 | 600 | 100 | 150 | 8 |
| 13 | 0.60 | 0.35 | 0.05 | 0.50 | 0.45 | 0.05 | 550 | 100 | 120 | 6 | 550 | 100 | 150 | 6 |
| 14 | 0.60 | 0.35 | 0.05 | 0.50 | 0.45 | 0.05 | 400 | 50 | 200 | 10 | 400 | 50 | 120 | 10 |
| 15 | 0.70 | 0.27 | 0.03 | 0.60 | 0.37 | 0.03 | 500 | 100 | 120 | 8 | 500 | 100 | 120 | 8 |
| 16 | 0.70 | 0.27 | 0.03 | 0.60 | 0.37 | 0.03 | 550 | 100 | 180 | 5 | 550 | 100 | 180 | 5 |
| 17 | 0.60 | 0.35 | 0.05 | 0.50 | 0.40 | 0.10 | 450 | 50 | 120 | 7 | 450 | 50 | 120 | 7 |
| 18 | 0.70 | 0.22 | 0.08 | 0.50 | 0.45 | 0.05 | 650 | 400 | 120 | 7 | 650 | 400 | 150 | 7 |
| 19 | 0.60 | 0.35 | 0.05 | 0.50 | 0.45 | 0.05 | 450 | 100 | 150 | 9 | 450 | 100 | 150 | 9 |
| 20 | 0.61 | 0.32 | 0.07 | 0.50 | 0.45 | 1.05 | 400 | 100 | 120 | 5 | 400 | 100 | 150 | 5 |
| 21 | 0.55 | 0.30 | 0.15 | 0.45 | 0.40 | 0.15 | 550 | 30 | 120 | 7 | 550 | 30 | 180 | 7 |

TABLE 2

| | Target material composition | | | | | | Upon first unit layer forming | | | | Upon second unit layer forming | | | |
|---|---|---|---|---|---|---|---|---|---|---|---|---|---|---|
| | | | | Second unit | | | Base material | Bias | Arc | Reaction | Base material | Bias | Arc | Reaction |
| Sample | First unit layer | | | layer | | | temperature | voltage | current | gas pressure | temperature | voltage | current | gas pressure |
| No. | Ti | Al | B | Ti | Al | B | ° C. | V | A | Pa | ° C. | V | A | Pa |
| 22 | 0.60 | 0.35 | 0.05 | 0.50 | 0.45 | 0.05 | 500 | 100 | 200 | 10 | 500 | 100 | 80 | 10 |
| 23 | 0.61 | 0.32 | 0.07 | 0,60 | 0.30 | 0.10 | 400 | 100 | 100 | 8 | 400 | 100 | 150 | 8 |
| 24 | 0.60 | 0.35 | 0.05 | 0.50 | 0.45 | 0.05 | 550 | 150 | 150 | 5 | 550 | 150 | 150 | 5 |
| 25 | 0.54 | 0.44 | 0.02 | 0.50 | 0.45 | 0.05 | 450 | 100 | 120 | 7 | 450 | 100 | 100 | 7 |
| 26 | 0.65 | 0.25 | 0.10 | 0.50 | 0.40 | 0.10 | 550 | 150 | 150 | 10 | 550 | 150 | 150 | 10 |
| 27 | 0.70 | 0.27 | 0.03 | 0.60 | 0.37 | 0.03 | 400 | 100 | 120 | 5 | 450 | 100 | 120 | 5 |
| 28 | 0.65 | 0.25 | 0.10 | 0,50 | 0.45 | 0.05 | 500 | 100 | 150 | 7 | 500 | 100 | 100 | 7 |
| 29 | 0.60 | 0.35 | 0.05 | 0.50 | 0.45 | 0.05 | 600 | 200 | 150 | 5 | 600 | 200 | 150 | 5 |
| 1-1 | 0.54 | 0.44 | 0.02 | 0.40 | 0.56 | 0.04 | 450 | 100 | 150 | 8 | 450 | 100 | 150 | 8 |
| 1-2 | 0.77 | 0.20 | 0.03 | 0.60 | 0.37 | 0.03 | 500 | 100 | 150 | 5 | 500 | 100 | 100 | 5 |
| 1-3 | 0.55 | 0.30 | 0.15 | 0.45 | 0.40 | 0.15 | 500 | 50 | 200 | 5 | 500 | 50 | 200 | 5 |
| 14 | 0.65 | 0.35 | 0.00 | 0.50 | 0.50 | 0.00 | 450 | 150 | 120 | 10 | 450 | 150 | 120 | 10 |
| 1-5 | 0.65 | 0.25 | 0.10 | 0.60 | 0.30 | 0.10 | 400 | 50 | 150 | 6 | 400 | 50 | 150 | 6 |
| 1-6 | 0.65 | 0.25 | 0.10 | 0.45 | 0.45 | 0.10 | 600 | 400 | 100 | 7 | 600 | 400 | 150 | 7 |
| 1-7 | 0.70 | 0.22 | 0.08 | 0.50 | 0.40 | 0.10 | 450 | 200 | 80 | 7 | 450 | 200 | 80 | 7 |
| 1-8 | 0.65 | 0.25 | 0.10 | 0,45 | 0.40 | 0.15 | 650 | 30 | 200 | 7 | 650 | 30 | 200 | 7 |
| 1-9 | 0.50 | 0.44 | 0.06 | 0.45 | 0.45 | 0.10 | 550 | 100 | 120 | 8 | 550 | 100 | 150 | 8 |
| 1-10 | 0.50 | 0.45 | 0.05 | 0.50 | 3.45 | 0.05 | 500 | 200 | 150 | 9 | 500 | 200 | 150 | 9 |

### <Evaluation>

### <<Composition of Coating>>

The coating of each sample was measured regarding compositions of the first unit layer and second unit layer, the thickness and the number of stacking of the first unit layer, the thickness and the number of stacking of the second unit layer, the thickness and the number of stacking of the first layer, the percentage of the number of atoms of titanium to the total number of atoms of titanium, aluminum and boron (denoted as the “Ti content in First layer” in Tables 5 and 6) in the first layer, the maximum value of diameter D of the largest inscribed circle of the crystal grain in the first layer (denoted as “Diameter of largest inscribed circle D” in Tables 5 and 6), the half width of a diffraction peak derived from the (200) plane of the cubic crystal in a X-ray diffraction spectrum of the first layer (denoted as “XRD half width” in Tables 5 and 6), nanoindentation hardness H of the first layer (denoted as “Hardness H” in Tables 5 and 6), and Young's modulus E of the first layer. The measurement methods for each item is as described in Embodiment 1. Moreover, HIE was calculated based on the measured values of nanoindentation hardness H and Young's modulus E of the first layer. The results are shown in Tables 3 to 6.

TABLE 3

| | | | | | | | | | First unit layer | | Second unit layer | | First layer | |
|---|---|---|---|---|---|---|---|---|---|---|---|---|---|---|
| | First unit layer | | | Second unit layer | | | | | Thick- | Number | Thick- | Number | Thick- | Number |
| Sample | composition | | | composition | | | | | ness | of | ness | of | ness | of |
| No. | a | b | c | d | e | f | a − d | e − b | (nm) | stacking | (nm) | stacking | (μm) | stacking |
| 1 | 0.54 | 0.45 | 0.01 | 0.44 | 0.55 | 0.01 | 0.10 | 0.10 | 15 | 261 | 8 | 261 | 6.0 | 522 |
| 2 | 0.68 | 0.25 | 0.07 | 0.62 | 0.36 | 0.02 | 0.06 | 0.11 | 20 | 200 | 20 | 200 | 8.0 | 400 |
| 3 | 0.64 | 0.34 | 0.01 | 0.51 | 0.39 | 0.10 | 0.13 | 0.05 | 15 | 167 | 15 | 167 | 5.0 | 334 |
| 4 | 0.66 | 0.32 | 0.02 | 0.59 | 0.40 | 0.01 | 0.07 | 0.08 | 30 | 177 | 32 | 177 | 11.0 | 354 |
| 5 | 0.63 | 0.32 | 0.06 | 0.57 | 0.40 | 0.03 | 0.06 | 0.08 | 12 | 111 | 15 | 111 | 3.0 | 222 |
| 6 | 0.69 | 0.27 | 0.04 | 0.50 | 0.46 | 0.04 | 0.19 | 0.19 | 26 | 273 | 18 | 273 | 12.0 | 546 |
| 7 | 0.64 | 0.30 | 0.06 | 0.52 | 0.39 | 0.09 | 0.12 | 0.09 | 7 | 267 | 8 | 267 | 4.0 | 534 |
| 8 | 0.61 | 0.36 | 0.03 | 0.52 | 0.41 | 0.07 | 0.09 | 0.05 | 35 | 79 | 28 | 79 | 5.0 | 158 |
| 9 | 0.56 | 0.42 | 0.02 | 0.51 | 0.47 | 0.02 | 0.05 | 0.05 | 2 | 250 | 2 | 250 | 1.0 | 500 |
| 10 | 0.60 | 0.35 | 0.05 | 0.48 | 0.51 | 0.02 | 0.12 | 0.16 | 49 | 200 | 49 | 200 | 20.0 | 400 |
| 11 | 0.68 | 0.26 | 0.06 | 0.49 | 0.46 | 0.05 | 0.19 | 0.20 | 24 | 160 | 26 | 160 | 8.0 | 320 |
| 12 | 0.72 | 0.27 | 0.01 | 0.53 | 0.44 | 0.03 | 0.19 | 0.17 | 11 | 391 | 12 | 391 | 9,0 | 782 |
| 13 | 0.63 | 0.33 | 0.04 | 0.54 | 0.44 | 0.02 | 0.08 | 0.11 | 15 | 167 | 21 | 167 | 6.0 | 334 |
| 14 | 0.67 | 0.28 | 0.05 | 0.53 | 0.43 | 0.04 | 0.14 | 0.15 | 46 | 70 | 25 | 70 | 5.0 | 140 |
| 15 | 0.75 | 0.24 | 0.02 | 0.6 | 0.36 | 0.03 | 0.14 | 0.12 | 9 | 556 | 9 | 556 | 10.0 | 1112 |
| 16 | 0.74 | 0.25 | 0.01 | 0.59 | 0.38 | 0.02 | 0.15 | 0.13 | 18 | 500 | 16 | 500 | 17.0 | 1000 |
| 17 | 0.64 | 0.32 | 0.05 | 0.53 | 0.42 | 0.05 | 0.11 | 0.11 | 4 | 333 | 5 | 333 | 3.0 | 666 |
| 18 | 0.69 | 0.27 | 0.04 | 0.56 | 0.40 | 0.04 | 0.13 | 0.13 | 31 | 74 | 37 | 74 | 5.0 | 148 |
| 19 | 0.62 | 0.35 | 0.03 | 0.55 | 0.42 | 0.03 | 0.07 | 0.07 | 11 | 450 | C33 | 450 | 9.0 | 900 |
| 20 | 0.66 | 0.30 | 0.04 | 0.50 | 0.47 | 0.03 | 0.16 | 0.17 | 35 | 232 | 47 | 232 | 19.0 | 464 |

TABLE 4

| | First unit layer | | | Second unit layer | | | | | First unit layer | | Second unit layer | | First layer | |
|---|---|---|---|---|---|---|---|---|---|---|---|---|---|---|
| Sample | composition | | | composition | | | | | Thickness | Number of | Thickness | Number of | Thickness | Number of |
| No. | a | b | c | d | e | f | a − d | e − b | (nm) | stacking | (nm) | stacking | (μm) | stacking |
| 21 | 0.57 | 0.33 | 0.10 | 0.48 | 0.43 | 0.10 | 0.09 | 0.09 | 12 | 194 | 19 | 194 | 6.0 | 388 |
| 22 | 0.66 | 0.32 | 0.03 | 0.54 | 0.43 | 0.03 | 0.11 | 0.11 | 31 | 116 | 12 | 116 | 5.0 | 232 |
| 23 | 0.66 | 0.28 | 0.06 | 0.60 | 0.35 | 0.06 | 0.06 | 0.07 | 8 | 682 | 14 | 682 | 15.0 | 1364 |
| 24 | 0.64 | 0.34 | 0.03 | 0.53 | 0.44 | 0.03 | 0.11 | 0.11 | 22 | 85 | 25 | 85 | 4.0 | 170 |
| 25 | 0.56 | 0.42 | 0.02 | 0.47 | 0.51 | 0.02 | 0.09 | 0.09 | 5 | 1500 | 3 | 1500 | 12.0 | 3000 |
| 26 | 0.61 | 0.30 | 0.08 | 0.51 | 0.41 | 0.08 | 0.11 | 0.11 | 11 | 857 | 10 | 857 | 18.0 | 1714 |
| 27 | 0.74 | 0.25 | 0.01 | 0.64 | 0.35 | 0.01 | 0.10 | 0.10 | 8 | 467 | 7 | 467 | 7.0 | 934 |
| 28 | 0.68 | 0.28 | 0.04 | 0.49 | 0.47 | 0.04 | 0.19 | 0.19 | 27 | 217 | 19 | 217 | 10.0 | 434 |
| 29 | 0.61 | 0.36 | 0.03 | 0.51 | 0.47 | 0.03 | 0.10 | 0.10 | 13 | 250 | 15 | 250 | 7.0 | 500 |
| 1-1 | 0.53 | 0.45 | 0.02 | 0.43 | 0.55 | 0.02 | 0.10 | 0.10 | 15 | 241 | 14 | 241 | 7.0 | 482 |
| 1-2 | 0.78 | 0.20 | 0.03 | 0.67 | 0.31 | 0.03 | 0.11 | 0.11 | 18 | 167 | 12 | 167 | 5.0 | 334 |
| 1-3 | 0.56 | 0.32 | 0.12 | 0.47 | 0.41 | 0.12 | 0.09 | 0.09 | 22 | 190 | 20 | 190 | 8.0 | 380 |
| 1-4 | 0.64 | 0.36 | 0.00 | 0.55 | 0.45 | 0.00 | 0.09 | 0.09 | 10 | 316 | 9 | 316 | 6.0 | 632 |
| 1-5 | 0.65 | 0.28 | 0.07 | 0.61 | 0.32 | 0.07 | 0.04 | 0.04 | 41 | 157 | 29 | 157 | 11.0 | 314 |
| 1-6 | 0.66 | 0.29 | 0.05 | 0.44 | 0.51 | 0.05 | 0.22 | 0.22 | 8 | 250 | 12 | 250 | 5.0 | 500 |
| 1-7 | 0.71 | 0.23 | 0.06 | 0.53 | 0.41 | 0.06 | 0.18 | 0.18 | 1 | 250 | 1 | 250 | 0.5 | 500 |
| 1-8 | 0.60 | 0.31 | 0.09 | 0.50 | 0.41 | 0.09 | 0.10 | 0.10 | 60 | 182 | 61 | 182 | 22.0 | 364 |
| 1-9 | 0.53 | 0.42 | 0.05 | 0.43 | 0.52 | 0.05 | 0.10 | 0.10 | 13 | 321 | 15 | 321 | 9.0 | 642 |
| 1-10 | 0.55 | 0.42 | 0.03 | 0.55 | 0.42 | 0.03 | 0.00 | 0.00 | 63 | 32 | 61 | 32 | 4.0 | 64 |

TABLE 5

| | First layer | | | | | | | |
|---|---|---|---|---|---|---|---|---|
| | | Diameter of | | | Young’s | | Cutting test 1 | Cutting test 2 |
| Sample | Ti content | largest inscribed | XRD half | Hardness | modulus | | Cutting time | Cutting time |
| No. | (%) | circle D (nm) | width (°) | H (GPa) | E (GPa) | H/E | (minutes) | (minutes) |
| 1 | 51 | 33 | 0.5 | 35 | 482 | 0.073 | 29 | 15 |
| 2 | 65 | 21 | 0.8 | 33 | 439 | 0.075 | 33 | 15 |
| 3 | 58 | 17 | 1 | 31 | 392 | 0.079 | 25 | 21 |
| 4 | 63 | 31 | 0.6 | 34 | 466 | 0.073 | 36 | 12 |
| 5 | 59 | 29 | 0.6 | 32 | 418 | 0.077 | 25 | 19 |
| 6 | 61 | 18 | 0.9 | 37 | 487 | 0.076 | 39 | 18 |
| 7 | 58 | 41 | 0.5 | 32 | 387 | 0.083 | 24 | 23 |
| 8 | 57 | 27 | 0.7 | 41 | 518 | 0.079 | 30 | 19 |
| 9 | 54 | 15 | 0.9 | 40 | 562 | 0.071 | 27 | 9 |
| 10 | 54 | 20 | 0.9 | 39 | 533 | 0.073 | 42 | 9 |
| 11 | 58 | 12 | 1.6 | 37 | 511 | 0.072 | 36 | 15 |
| 12 | 62 | 20 | 0.9 | 33 | 426 | 0.077 | 34 | 16 |
| 13 | 58 | 42 | 0.5 | 39 | 533 | 0.073 | 33 | 17 |
| 14 | 62 | 50 | 0.4 | 31 | 409 | 0.076 | 26 | 18 |
| 15 | 88 | 35 | 0.5 | 32 | 441 | 0.073 | 35 | 14 |
| 18 | 67 | 57 | 0.3 | 38 | 555 | 0.068 | 38 | 9 |
| 17 | 58 | 112 | 0.2 | 29 | 430 | 0.067 | 25 | 13 |
| 18 | 62 | 9 | 2 | 38 | 539 | 0.071 | 31 | 15 |
| 19 | 59 | 30 | 0.5 | 33 | 467 | 0.071 | 35 | 13 |
| 20 | 57 | 241 | 0.1 | 34 | 491 | 0.069 | 36 | 9 |
| 21 | 51 | 6 | 2.2 | 29 | 401 | 0.072 | 26 | 15 |
| 22 | 62 | 46 | 0.4 | 30 | 422 | 0.071 | 25 | 16 |

TABLE 6

| | First layer | | | | | | | |
|---|---|---|---|---|---|---|---|---|
| | | Diameter of | | Hardness | Young’s | | Cutting test 1 | Cutting test 2 |
| Sample | Ti content | largest inscribed | XRD half | H | modulus E | | Cutting time | Cutting time |
| No. | (%) | circle D (nm) | width (°) | (GPa) | (GPa) | H/E | (minutes) | (minutes) |
| 23 | 63 | 25 | 0.7 | 37 | 509 | 0.073 | 39 | 11 |
| 24 | 58 | 35 | 0,6 | 29 | 402 | 0.072 | 24 | 13 |
| 25 | 53 | 13 | 1.5 | 33 | 471 | 0.070 | 36 | 12 |
| 26 | 56 | 21 | 0.8 | 38 | 535 | 0.071 | 41 | 10 |
| 27 | 69 | 12 | 1.6 | 33 | 481 | 0.069 | 33 | 12 |
| 28 | 60 | 29 | 0.6 | 28 | 404 | 0.069 | 28 | 13 |
| 29 | 56 | 221 | 0.1 | 29 | 412 | 0.070 | 27 | 14 |
| 1-1 | 48 | 96 | 0.2 | 29 | 471 | 0.062 | 13 | 3 |
| 1-2 | 74 | 78 | 0.2 | 28 | 396 | 0.071 | 16 | 6 |
| 1-3 | 52 | 7 | 2.1 | 22 | 361 | 0.061 | 11 | 2 |
| 1-4 | 60 | 239 | 0.1 | 29 | 526 | 0.055 | 15 | 4 |
| 1-5 | 63 | 23 | 0.8 | 30 | 451 | 0.067 | 16 | 6 |
| 1-6 | 53 | 31 | 0.5 | 38 | 512 | 0.074 | 16 | 5 |
| 1-7 | 62 | 32 | 0.5 | 36 | 472 | 0.076 | 9 | 5 |
| 1-8 | 55 | 48 | 0.3 | 33 | 467 | 0.071 | 32 | 1 |
| 1-9 | 48 | 49 | 0.3 | 28 | 428 | 0.065 | 15 | 6 |
| 1-10 | 55 | 27 | 0.6 | 32 | 477 | 0.067 | 15 | 2 |

### <<Cutting Test 1>>

A cutting test was carried out by using the cutting tool of each sample under the following conditions, and a cutting time (minutes) until the width of crater wear reached 0.3 mm or more was measured. The cutting time longer than 24 minutes is determined that the cutting tool has excellent wear resistance. The results are shown in the “Cutting test 1” column of Tables 5 and 6.

(Cutting Conditions)

Workpiece: Stainless steel

Cutting speed: 250 m/min

Feed rate: 0.1 mm/t

Depth of cut: 1.0 mm

Dry cutting

Center cut

The above cutting conditions correspond to those for stainless steel milling (high-speed, low-feed machining).

### <<Cutting Test 2>>

A cutting test was carried out by using the cutting tool of each sample under the following conditions, and a cutting time (minutes) until the width of flank wear reached mm or more was measured. The cutting time longer than 9 minutes is determined that the cutting tool has excellent chipping resistance. The results are shown in the “Cutting test 2” column of Tables 5 and 6.

(Cutting Conditions)

Workpiece: Stainless steel

Cutting speed: 100 m/min

Feed rate: 0.5 mm/t

Depth of cut: 2.0 mm

Dry cutting

Center cut

The above cutting conditions correspond to those for stainless steel milling (low-speed, high-feed machining).

### <Considerations>

The cutting tools of Samples 1 to 29 correspond to Examples. Samples 1 to 29 (Examples) were confirmed to have excellent wear resistance and chipping resistance and long tool lives.

The cutting tools of Sample 1-1 to Sample 1-10 correspond to Comparative Examples. The first unit layer and the second unit layer have the same composition in Sample 1-10. Namely, Sample 1-10 has a single layer with uniform composition. Sample 1-1 to Sample 1-10 were confirmed to have insufficient wear resistance and/or chipping resistance and insufficient tool lives.

The embodiments and Examples of the present disclosure have been explained as described above, however appropriate combinations of each aforementioned embodiment and the configurations of Examples as well as variations thereof in various ways, have been contemplated from the beginning. The embodiments and Examples disclosed herein are illustrative in all respects and should be considered not restrictive. The scope of the present disclosure is indicated by the claims, not by the aforementioned embodiments and Examples, and is intended to include the meaning equivalent to the scope of the claims and all modifications within the scope.

### REFERENCE SIGNS LIST

1 first unit layer, 2 second unit layer, 10 base material, 20 coating, 21 first layer, 22 second layer, 23 third layer, 24, 24a, 24b, and 24c crystal grains, 25 grain boundary, atom, 100 cutting tool, 200 deposition apparatus, 201 chamber, 202 gas inlet port, 203 gas exhaust port, 204 rotary table, 205 base material holder, 206 bias power supply, 211, 212, 213, and 214 target materials, 221 and 222 direct current power supply.

1. A cutting tool comprising a base material and a coating arranged on the base material, wherein
the coating comprises a first layer;
the first layer has a multilayer structure in which a first unit layer and a second unit layer are alternately stacked;
a thickness of the first unit layer is 2 nm or more and less than 50 nm;
a thickness of the second unit layer is 2 nm or more and less than 50 nm;
a thickness of the first layer is 1.0 μm or more and 20 μm or less,
the first unit layer is composed of TiₐAl_{b}B_{c}N, and
the second unit layer is composed of Ti_{d}AlₑB_{f}N,
wherein
0.54≤a≤0.75,
0.24≤b≤0.45,
0<c≤0.10,
a+b+c=1.00,
0.44≤d≤0.65,
0.34≤e≤0.55,
0<f≤0.10,
d+e+f=1.00,
0.05≤a−d≤0.20, and
0.05≤e−b≤0.20 are satisfied, and
a percentage of the number of atoms of titanium to the total number of atoms of titanium, aluminum and boron is 50% or more in the first layer.

2. The cutting tool according to claim 1, wherein
the first layer is composed of a plurality of crystal grains, and
the diameter of the largest inscribed circle of the crystal grain is 50 nm or smaller.

3. The cutting tool according to claim 1, wherein in an X-ray diffraction spectrum of the first layer, a half width of a diffraction peak derived from (200) plane of a cubic crystal is 0.2° or more and 2.0° or less.

4. The cutting tool according to claim 1, wherein a nanoindentation hardness H of the first layer at 25° C. is 30 GPa or greater.

5. The cutting tool according to claim 1, wherein a ratio of a nanoindentation hardness H(GPa) of the first layer at 25° C. to a Young's modulus E(GPa) of the first layer at 25° C., H/E, is 0.070 or more.
